(19) United States
(12) Patent Application Publication
(10) Pub. No.: US 2006/0048777 A1
(43) Pub. Date: Mar. 9, 2006

(54) Apparatus and method for providing breathable air and bodily protection in a contaminated environment

(75) Inventor: Michael J. Brookman, Branford, CT (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: INTERSPIRO, INC., Branford, CT (US)

(21) Appl. No.: 11/186,044

(22) Filed: Jul. 21, 2005

Related U.S. Application Data
(63) Continuation-in-part of application No. 10/675,135, filed on Sep. 29, 2003.
Application No. 10/675,135 is a continuation of application No. 10/393,346, filed on Mar. 21, 2003.
(60) Provisional application No. 60/590,621, filed on Jul. 23, 2004.

(51) Int. Cl. A62B 17/04; A62B 9/00

(52) U.S. Cl. 128/201.22; 128/205.22

(57) ABSTRACT

An apparatus for protecting a user in a hazardous or contaminated environment caused by chemical, fire, biological, and/or nuclear contamination includes a self-contained breathing apparatus (SCBA) for providing tank stored breathable air, a powered air purifying respirator (PAPR) for purifying ambient air and a valve system that can be used to control the source of air from either the SCBA or the PAPR. The source of breathable air can be selectively controlled via manual or automatic controls while a protective body suit can be operably coupled with the SCBA and the PAPR to protect a user within the contaminated environment.

### CROSS REFERENCES TO RELATED APPLICATIONS

The present application is a non-provisional application of co-pending provisional application No. 60/590,621, filed on Jul. 23, 2004, entitled “Apparatus and Method for Providing Breathable Air and Bodily Protection in a Contaminated Environment,” and is a continuation-in-part of co-pending application Ser. No. 10/675,135, filed on Sep. 29, 2003, entitled “Powered Air Purifying Respirator System and Breathing Apparatus,” which a continuation of application Ser. No. 10/393,346, filed Mar. 21, 2003, entitled “Powered Air Purifying Respirator System and Breathing Apparatus,” and are all hereby incorporated by reference in their entirety for all purposes.

### FIELD OF TECHNOLOGY

This invention is generally directed to an apparatus for protecting a user in hazardous environments, and more particularly relates to an apparatus for purifying contaminated air and providing portable clean air to a user, as well as preventing contaminated substances from contacting the user's body.

### BACKGROUND

There are, at present two systems for assisting the breathing of persons, such as firefighters, rescue workers, etc., who are frequently subject to contaminated air. First, there are the supplied air respirators also known as self contained breathing apparatus (SCBA) that feed compressed (e.g. bottled) air to a tight fitting face mask, or other conduit closely fit to the mouth and/or nose, for inhaling by the user. These systems do not rely on the ambient atmosphere for respiration. Second, there are filtered-air systems that use filter elements, in connection with a respirator apparatus, to clean the ambient atmosphere making it suitable for breathing. Such filter systems may or may not make use of auxiliary power. In powered filter systems, ambient atmosphere is drawn through a suitable filter/decontamination means, or other purifying means, by a powered blower or the like, so that the contaminated ambient air is rendered breathable. The purified resultant air is fed to a headpiece of some kind, such as a tight fitting face mask. These systems are generally known as powered air purifying respirators (PAPRs). Both types of breathing assists are used by personnel who are subject to breathing ambient atmosphere that would otherwise be considered to include harmfully contaminated, unbreathable or dangerous air.

Generally speaking, dangerous or unbreathable atmosphere includes air containing less than 19.5 volume percent oxygen, or air with the requisite oxygen but also containing significant proportions of harmful contaminants, e.g. particulate or gaseous contaminants. It will be appreciated that, in some situations where the oxygen content is at least 19.5 percent, the wearer may be able to enter an area that has a contaminated atmosphere using only a filter system, provided the filter is capable of meeting the challenge of cleaning the atmosphere and enabling the user to breathe and still preserve his or her health. The filter can be provided with means to eliminate harmful constituents or contaminants in the wearer's ambient atmosphere. In particular, filter based decontamination systems, that is systems that purify an ambient atmosphere that has become contaminated so as to convert the atmosphere to breathable air, work best when they pass an air supply under regulated flow through a cleaning element (such as a suitable filter).

Generally, a pump/blower is used to draw the contaminated atmosphere through a filter, and perhaps into contact with a material that ameliorates the contaminant(s), and to then force the purified, e.g. filtered, air under positive pressure into a face mask or other means associated with the breathing of the wearer, such as a mouth grip, hood or helmet. While a powered air supplying means, such as a battery operated pump/blower means, is probably preferred, it is also known that air cleaning systems that are not powered by external means can be used. In these unpowered systems, the user's lung power provides the necessary impetus to force contaminated air through the cleaning element. For simplicity, this means of cleaning ambient atmosphere will be referred to as an air purifying respirator (APR). Systems which force air through a filter using a powered pump or blower arrangement (powered by, for example, a battery, line current or other power source), are known as powered air purifying respirators (PAPRs)

A PAPR system is able to protect against contaminants so long as the oxygen level in the purified air is above 19.5 volume percent and provided the contaminants can be removed by filtration, that is, the soot and smoke or other contaminants can be ameliorated by reaction deposition with a suitable purifying material. In practical effect, these systems have been designed to use replaceable filter(s) and air purifying element(s). However, PAPR systems are not appropriate where the ambient atmosphere has an oxygen content that is less than 19.5 percent by volume.

Thus, situations exist in which a PAPR or an APR cannot be used. These situations include where the ambient atmosphere is so contaminated, or the contamination is such that a filter and/or decontamination/purifier system cannot handle the problem; and/or where the oxygen content of the ambient air is too low to satisfy human survival needs (that is, where the atmosphere is IDLH, meaning that the ambient atmosphere is of Immediate Danger to Life and Health). In those circumstances, a person entering the contaminated area must take his or her own air supply along with him or her. This action is akin to a SCUBA diver carrying his air with him in the form of a container (bottle) having compressed, clean air stored therein.

One problem is that a wearer of a SCBA must support all of the weight of the bottled air whereas, in water, a diver has the advantage of the water's buoyancy to help support the weight of the SCUBA tanks. As a result, most SCBA systems are only capable of carrying enough bottled, compressed air for about an hour. It would, of course, be desirable to be able to increase the time that a user, for example a fire fighter, can work in a hostile environment dependent upon bottled air while at the same time minimizing the weight that the person must carry to support him or her for that additional time.

It will be appreciated that air bottles are heavy, especially when they are full. In the case of fire fighters, who are already going into an unfriendly environment carrying their tools with them, the heat of the fire makes it even more difficult to carry the extra weight of the compressed air container. Further, the fire fighter will have to exit the contaminated building when the SCBA system runs low on air.

Thus, when carrying around ones' own air supply, there is a very real practical limit as to how much air can be safely carried. Contrary to operating under water with a SCUBA rig, the air bottles used by firefighters are quite heavy, must be supported entirely by the wearer, and do not have the advantage of water buoyancy partially supporting their weight. Making SCBA systems larger, to be able to carry more air, increases their weight but decreases their portability. This combination of weight and working conditions severely limits the time that a fire fighter, who is wearing/carrying his own air supply and tools, can effectively fight the fire.

However, there exists situations in which a fire fighter, for example, does not need carried air for some portion of the time that he or she is working on the fire, but does need portable, bottled air for other portions of the time that he or she is working on the fire. Unfortunately, existing systems are suited to one or the other situation. That is, the existing systems either provide positive pressure (pumped) filtering and purification systems to convert contaminated ambient atmosphere to air that is clean enough to breathe safely, or they provide bottled air under pressure that is carried by the person to be used instead of the ambient atmosphere. While both systems have deficiencies, each system has advantages, and even necessities, under critical conditions.

While the above and following comments use a fire fighter as an illustrative example of the type of person who will benefit from using a combined PAPR and SCBA system, this system is by no means limited in use to fire fighters. For example, workers in chemical plants and refineries may have substantial need for the benefits available from the system described herein. Likewise, soldiers in the field that are being subjected to chemical or biological attack will benefit greatly from the system described herein. It will, of course, be apparent to those of ordinary skill in the art that others will similarly be assisted by the system described herein.

### SUMMARY OF THE DISCLOSURE

A breathing apparatus includes a self-contained breathing apparatus (SCBA) for providing tank-stored air to a user and a powered air purifying respirator (PAPR) for providing filtered ambient air to the user, via the use of a dual air source mask. The PAPR is operably coupled to the SCBA to permit selective control of the source of breathable air supplied to the user.

In an illustrative embodiment, the breathing apparatus further includes a fluid impervious body suit for preventing contaminated ambient air from contacting the user. The body suit may include a plurality of layers of material and may, for example, include an impermeable fluoro-polymer barrier positioned between an inner layer and an outer layer of fabric. The protective suit is operable for use in an unbreathable atmospheric environment caused by fire, chemical, biological, and/or radiation contamination. The suit may further include a dual air hood having an inner rubber face sealingly engaged with a chemical warfare mask. The hood can include an outer member drawn over the mask and tightly fitted over the mask lens frame. The dual hood is operable for providing a protective barrier to liquid and vapor phase agents to thereby reduce contaminant load at the interface of the mask and the skirt of the inner hood. For ease of understanding, further reference will be made to the use of a face mask. However, this use is illustrative and not limiting. A mouth piece can also serve the function of bringing breathable air to the user.

Under complete manual operation, the PAPR and SCBA are each connected to the face mask by separate breathing hoses, wherein each hose has its own entry point in the case of a dual entry face mask, or, each hose is connected to a “tee” piece, or similar connection device in the case of a single entry face mask. At or about the face mask, each hose is provided with a non-return (one-way) valve. An exhaust valve is provided in the face mask so that exhaust air is vented to the atmosphere. A valving and/or switching system is provided so that the wearer controls whether to receive cleaned ambient air or supplied (bottled) air, without exposure to uncleaned/contaminated ambient air. This valving and/or switching system can be manually operated by the user, in which case the user determines independently which air supply to use; or it can operate under semi-automatic control where the air supply from the SCBA and the PAPR are both connected to a valve manifold.

Initially, the SCBA supply is shut off and the PAPR blower is off, but filtered air from the PAPR flows to the face mask through resistance breathing. The wearer can switch the PAPR blower on if resistance breathing becomes too difficult. Either at the discretion of the wearer or in response to an audible and/or visual alarm, which may operate based on sampling and testing of the ambient air to indicate that the system should be switched from PAPR operation to SCBA operation, the wearer can open the SCBA supply valve and switch off the PAPR. If desired, the pressure of the SCBA air can trigger a switch to automatically shut off the PAPR, leaving the air supply solely from the SCBA. In the alternative, the decision as to whether to accept purified air from the filter assembly, or to demand air from the supplied air bottle means can operate automatically based on a sampling and testing means associated with the valving means, which would be electrically operated so as to open access to the SCBA system and close access to the PAPR system via the manifold valve.

At least one air bottle is provided with a connection to at least one port in the face mask and a controllable valve is provided that permits control as to whether to withdraw air from the bottle or not. At least one filter element separate from the air bottle along with a controllable valve system, permits control as to whether ambient air is taken in by the PAPR and fed to the mask. A battery or other powered electric motor driven blower, operatively attached between the filter element and the user, is controlled by a switch or a handle to enable the motor driven blower to be operated.

Thus, when the ambient air has sufficient oxygen content, and the contaminants are suited to removal by filtration or chemical treatment in the filter elements, the blower can be activated by operating the switch. At this point, ambient air will be powered through the filter element where it is purified of its harmful constituents, such as soot and other harmful particles, vapors or gases. Under manual operation when the ambient air has insufficient oxygen or the contaminants are such that they cannot be removed by filtration or other treatment in the filter elements, the valve of the SCBA is opened by the wearer, and the PAPR system is switched off. Ambient air is no longer taken in through the filter elements but, instead, air is now supplied by the SCBA system.

Where a face mask is used, it is suitably equipped with a one-way valve that enables exhausted, exhaled air to be vented regardless of whether the intake air is delivered through the filter element or from the bottled compressed air. If desired, the face mask may be used in conjunction with a closed circuit apparatus.

As is conventional, the bottled air is under substantial pressure and must have its pressure reduced to an extent sufficient to enable it to be breathed by the user without damage to the user's respiratory system. This procedure, and equipment to enable this procedure to be accomplished, is well known per se. In particular, commercially available first and second stage regulators can be used for this purpose. Thus, there are in effect two successive valving systems disposed between the air bottle and the face mask; namely, a first valve that is a simple open or close valve attached at or very near the air bottle; and a regulator, pressure reducing valving system disposed in the line between the first valve and the face mask.

### BRIEF DESCRIPTION OF THE DRAWINGS

FIG. 1A is an exploded perspective view of a breathing apparatus;

FIG. 1B is an assembled perspective view of the breathing apparatus of FIG. 1A;

FIG. 2A is an exploded perspective view of a further breathing apparatus;

FIG. 2B is an assembled perspective view of the breathing apparatus of FIG. 2A;

FIG. 3 is a schematic diagram of a first embodiment of an air supply system that may be used by the breathing apparatus of FIGS. 1 and 2;

FIG. 4 is a schematic diagram of a second embodiment of an air supply system that may be used by the breathing apparatus of FIGS. 1 and 2;

FIG. 5 is a schematic diagram of a third embodiment of an air supply system that may be used by the breathing apparatus of FIGS. 1 and 2;

FIG. 6 is a schematic diagram of a fourth embodiment of an air supply system that may be used by the breathing apparatus of FIGS. 1 and 2;

FIG. 7 is a schematic diagram of the fourth embodiment of an air supply system that may be used by the breathing apparatus of FIGS. 1 and 2 with some modifications;

FIG. 8A is a front perspective view of a protective suit with a breathing apparatus attached thereto;

FIG. 8B is a back perspective view of the protective suit and breathing apparatus of FIG. 8A; and

FIG. 9 is a detailed blow up of several layers of the protective suit of FIG. 8A.

### DETAILED DESCRIPTION

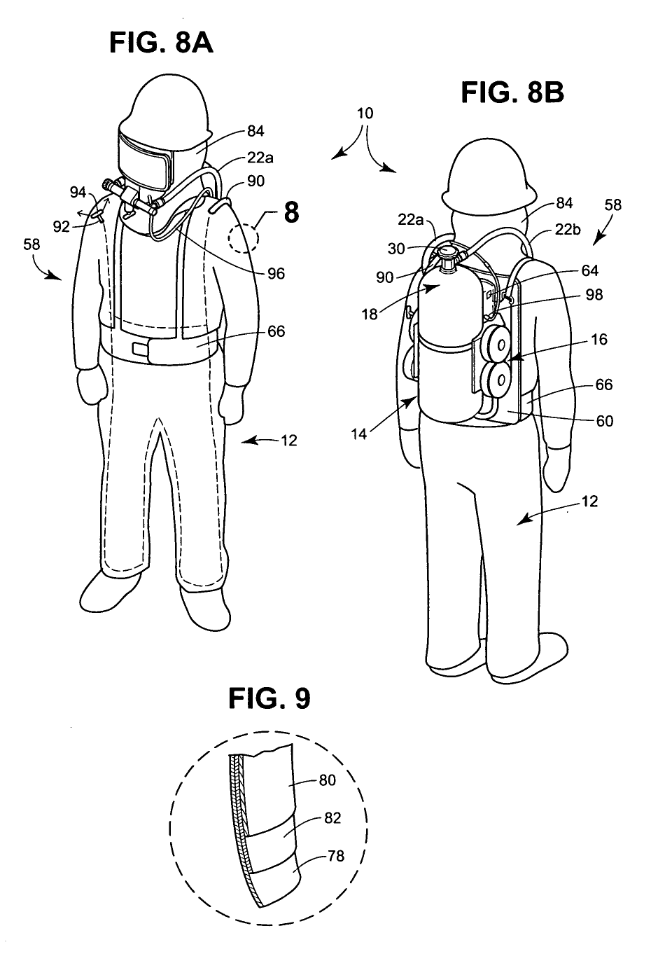

Referring first to FIGS. 8A and 8B, an apparatus 10 for protecting a user 58 in a contaminated environment includes a hazardous material “hazmat” protective body suit 12 with a breathing apparatus 14 including a powered air purifying respirator “PAPR” 16 in combination with a self-contained breathing apparatus “SCBA” 18. It should be noted that the breathing apparatus 14 may be utilized with or without the protective suit 12, but that the suit 12 and the breathing apparatus 14 can generally be used together to maximize protection in a contaminated environment caused by chemical, fire, biological, nuclear and/or other contamination.

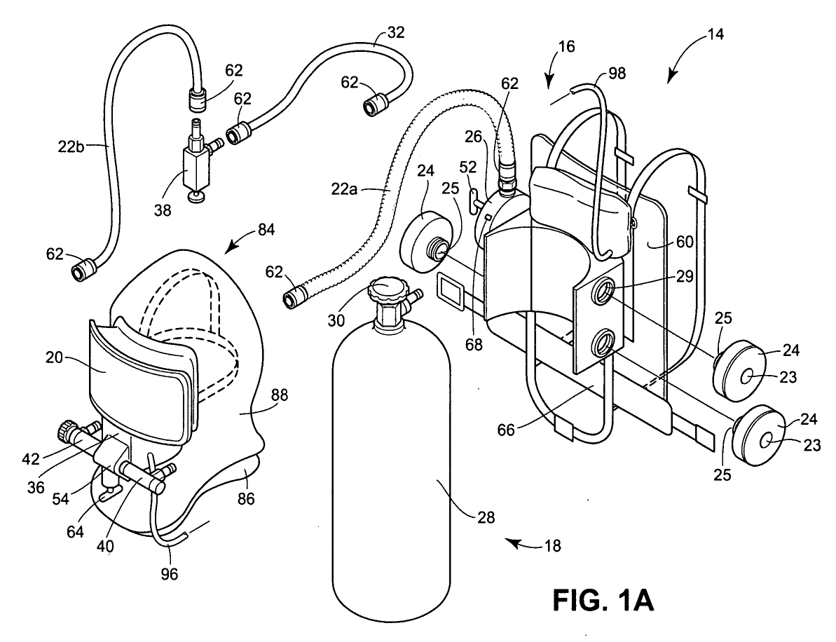

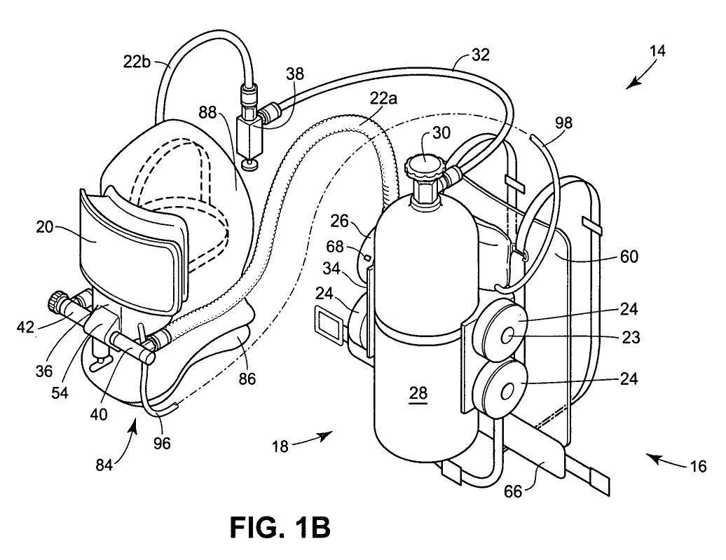

Referring now to FIGS. 1A and 1B, a first embodiment of the breathing apparatus 14 is shown in an exploded view (FIG. 1A) and a fully assembled view (FIG. 1B) as including the PAPR 16 and the SCBA 18. A traditional harness 66 may be used to hold different elements of the breathing apparatus 14 and to provide portability thereof. A ballistic protective barrier 60 can be positioned on the harness 66 between the SCBA 18 and the user to reduce risk of injury in the event of a tank rupture caused by foreign object damage such as a flying projectile or an external explosion.

In addition to the PAPR 16 and the SCBA 18, the breathing apparatus 14 can include a dual layer hood 84 having an inner rubber face skirt 86 and an outer protective member 88 tightly fitted around a face mask 20. The face mask 20 is adapted to be tightly fitted to the face of a user, not shown in FIGS. 1A and 1B, to prevent incursion by atmospheric contamination. A pair of conduits 22a, 22b connects the PAPR 16 and the SCBA 18 respectively, to the face mask 20. In particular, the conduit 22a provides filtered breathable air from the PAPR 16 while the conduit 22b provides bottled air from the SCBA 18.

As illustrated in FIGS. 1A and 1B, the PAPR 16 includes at least one or more filter elements 24, a powered blower 26, and a plenum 29. The filter elements 24 operate to filter contaminated ambient air and to provide breathable air to the face mask 20 for the user to breathe. Each filter element 24 includes an ambient air intake opening 23 and an outlet 25 for the filtered ambient air to pass through. The filter elements 24 connect to the filtered air plenum 29 via any suitable mechanical fastening means known to those skilled in the art such as, for example, a threaded engagement. The filter elements 24 can be used individually or in a plural configuration. Additionally, the filter elements 24 may be positioned on one side of the plenum 29, or alternatively, may be spaced intermittently along multiple sides of the plenum 29 as desired. The powered blower 26 is operably coupled to the plenum 29 for drawing ambient air through the filter elements 24 and supplying filtered air to the face mask 20 via the conduit 22a, which connects to a port 40 in fluid communication with a manifold 36. The manifold 36, in turn, is fluidically connected to the face mask 20. It should be noted that the PAPR 16 is fully operational, with or without the blower 26 being turned on, as will be discussed in more detail below.

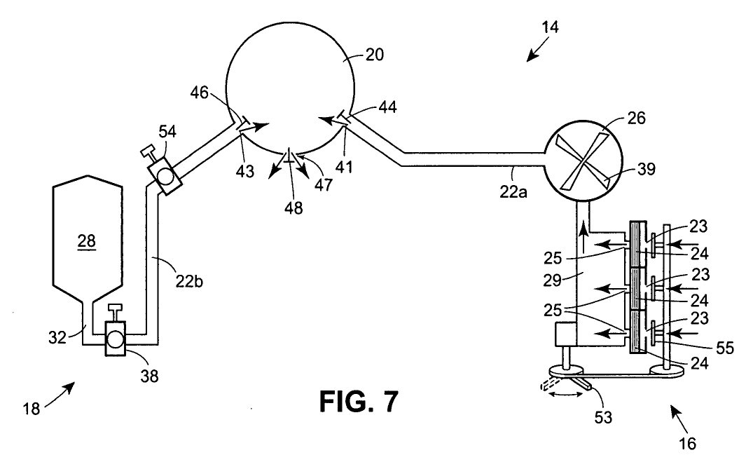

A valve 52 is connected to PAPR 16 and is adapted to shut off filtered airflow to the face mask 20. The valve 52 can include a rotary handle 53 for manual operation, but could also be electronically controlled such as by a solenoid. As illustrated in FIG. 7, the rotary handle 53 may be operatively connected to the filter elements 24 and, more specifically, may be connected to filter intake cover(s) 55. It is understood that the valve 52 and actuator handle 53 can be located at any desired location in the PAPR 16 system, but is depicted in FIGS. 1A and 1B proximate the blower 26. The blower 26 also includes an on/off switch 68 that operates independently from the valve 52, to allow conservation of battery power while the user breathes filtered air through resistance breathing. In this manner, the valve 52 allows the user to shut off the filtered airflow while the breathing apparatus 14 is operating in an SCBA mode so that the filter elements 24 are not unnecessarily contaminated, while the on/off switch 68 can be used to select between powered and resistance breathing when the valve 52 is open. If desired, the on/off switch 68 can be operationally coupled to the flow control valve 52 to ensure that the PAPR 16 airways are opened when the blower 26 of the PAPR 16 is switched on.

The SCBA 18 includes a compressed air tank 28 filled with breathable air or oxygen. The contents of the tank 28 can be compressed to approximately 4500 psi when the tank 28 is fully charged, but of course, other compression values can be used instead. The tank 28 may include a shut off valve 30 which may be a mechanically actuated valve as depicted in FIGS. 1A and 1B or an electronically actuated valve, as one skilled in the art would readily understand. As shown in FIGS. 1A and 1B, a first conduit 32 is connected to the tank 28 on one end and to a first stage pressure regulator 38 at the opposing end. When the shut off valve 30 is open, the compressed air is transported through a first conduit 32 to the first stage pressure regulator 38 which is operable for reducing the air pressure from the tank 28 pressure to a lower pressure, for example 100 psi. A second conduit 22b provides a connection between the first stage pressure regulator 38 and a manifold inlet port 42 so that compressed air is delivered through the conduit 22b to the port 42, which is fluidly connected to the manifold 36.

The air pressure from the tank 28 can still be too high for breathing even at the reduced pressure. As a result, a second stage pressure regulator 54 can be positioned in the manifold 36 to reduce the air pressure to a standard, atmospheric pressure of approximately 14.69 psia. Alternatively, the first stage pressure regulator 38 can reduce the air pressure to a standard atmospheric pressure without utilizing the second stage pressure regulator 54.

The conduits 22a, 22b, and 32 can be expandable hoses made from, for example, flexible tear-resistant material such as rubber with a stainless steel mesh cover to help prevent sharp objects from piercing the conduits 22a, 22b, 32. Quick coupling connectors 62 can be adapted to connect each end of the conduits 22a, 22b, 32 to mating receptacles on the breathing apparatus 14.

The face mask 20, if used without the hood 84, is sealingly engageable with the face of the user 58 to prevent ambient contaminants from entering into the breathing system. A control valve actuator 64 can be operably connected to a control valve in the manifold 36 for controlling which air supply, either the PAPR 16 or the SCBA 18, is fluidly connected to the face mask 20. The control valve actuator 64 can be manually or electronically actuated, and in the later case, the actuator 64 can be located in a remote location as is known to those skilled in the art.

A camelback member supply line 97 connects a camelback member 96 to the face mask 20. The camelback member supply line 97 is adapted to provide contaminant free liquid hydration from the camelback member 96 to the user without having to remove the face mask 20 and exposing the user to the contaminated atmosphere.

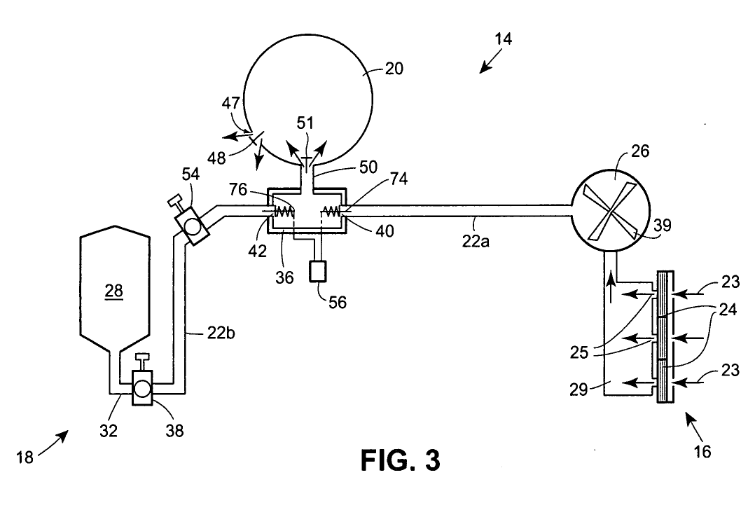

FIGS. 3-5 schematically illustrate optional configurations of the breathing system of FIGS. 1A and 1B, wherein the face mask 20 includes a manifold 36. The configurations shown in FIGS. 3-5 are not necessarily distinct configurations that must be utilized independently, but to the contrary, can be combined in any manner desired. Referring now specifically to FIG. 3, ambient air flows into the PAPR 16 through the inlets 23 of the individual filter elements 24. Filtered air exits the filter elements 24 through the outlets 25 and enters the filtered air plenum 29. The filter elements 24 contain suitable decontamination media for removing contaminates in both solid and fluid form. In this manner, the contaminated air is cleaned of solid particulate matter, harmful gases, and/or foul odors. Subject to the class of filter elements 24 installed in the PAPR 16 and the time spent in the contaminated area, the filter elements 24 may provide breathable air in a chemically, biologically and/or nuclear contaminated environment. As indicated previously, the ambient air can be drawn through the filter elements 24 by resistance breathing of the user or by the electrically powered blower 26. The electrically powered blower 26 is operably connected to the plenum 29 and is adapted to draw ambient air through the filter elements 24 and to force the filtered air through the conduit 22a toward the face mask 20. As shown in FIG. 3, the blower 26 includes an impeller 39, or the like, for generating suction forces. After the cleaned air is transported through the conduit 22a, the cleaned air enters the port 40 and flows into the manifold 36 via a one-way valve 74.

The SCBA 18 is operable for delivering compressed bottled air from the tank 28 when, for example, the PAPR 16 is not supplying air. Bottled air flows from the tank 28 into the first conduit 32 and through the first stage pressure regulator 38. The first stage pressure regulator 38 reduces the pressure of the compressed air to a desired level. The bottled air is then delivered to the second stage pressure regulator 54 via the second conduit 22b. As indicated above, the second stage pressure regulator 54 is operable for reducing the pressure of the compressed air to approximately 14.69 psia. The second stage pressure regulator 54 can be positioned in the manifold 36 or in a remote location as schematically depicted in FIG. 3. The bottled air then flows into the manifold 36 through the port 42 via a one-way valve 76.

Switching to SCBA 18 supplied air from PAPR 16 supplied air can be implemented automatically, semi-automatically or manually as will be described in more detail below. As illustrated in FIG. 3, the breathing apparatus 14 may include a gas sensor 56 that is operable for sensing the gas content of the air being delivered to the user. The sensor 56 is operable for signaling a warning alarm 69 if the filtered ambient air is not clean enough to breathe. The alarm 69 can be audible, visual or both. In this configuration, the sensor 56 can trigger the alarm 69, automatically shut down the PAPR 16 and cause bottled air from the SCBA 18 to flow to the face mask 20. The manifold inlet valves 74, 76 associated with for the PAPR 16 and the SCBA 18, respectively, can be electronically connected to the sensor 56 such that the inlet valve 74 from the PAPR 16 can be automatically closed and the inlet valve 76 from the SCBA 18 can be automatically opened when the PAPR 16 is not providing breathable air. The blower 26 will be automatically shut off via the electronic switch 68.

In any event, the air enters the face mask 20 from the manifold 36 through a face mask inlet port 50 when a face mask inlet valve 51 is open. The inlet valve 51 is a one-way valve that opens when the air pressure in the face mask 20 is lower than the air pressure in the manifold 36, i.e., when the user inhales. When the user exhales, the inlet valve 51 of the face mask 20 closes and the exhaled air exits through an outlet port 47, which also includes a one-way valve 48. In particular, the face mask outlet valve 48 is a one-way valve that opens when the user exhales because the air pressure in the face mask 20 is greater than the surrounding ambient pressure.

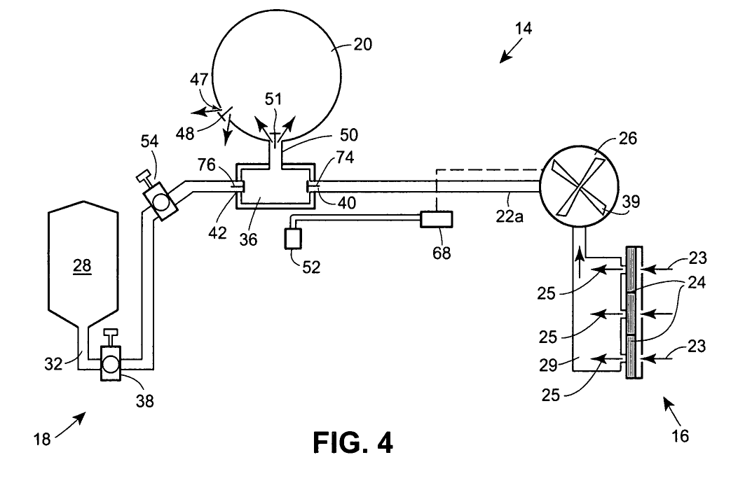

The configuration of FIG. 4 is similar to that of FIG. 3 except that it illustrates a semi-automatic mode of operation. An electronic on/off blower switch 68 and the valve actuator 64 for the PAPR are manually controlled in response to an audible or visible alarm 69 that is triggered by the sensor 56 when the PAPR 16 is not providing breathable air. The valve actuator 64 permits the user to manually switch the air source from the PAPR 16 to the SCBA 18.

The configuration of FIG. 5 includes the same features as that of FIGS. 3 and 4 with the exception of the gas sensor 56, the automatically controlled shut off switch 68, and the valve actuator 64 used to control the source of air. Instead, the configuration of FIG. 5 requires the user to shut down the blower 26 manually if PAPR 16 airflow is not desired or to conserve battery life of the blower 26. In this configuration, the face mask 20 will receive air from the supply source with the highest pressure. Thus, if the SCBA 18 is turned on, the air will be supplied from the SCBA 18 until the pressure in the tank 28 falls below the air supplied by the PAPR 16. If the blower 26 is deactivated, the SCBA 18 air pressure would have to fall below ambient pressure before the PAPR 16 would supply air to the face mask 20. Of course, if the SCBA 18 is turned off, air would be supplied by the PAPR 18 with either powered assist when the blower 26 is turned on, or through resistance breathing when the blower 26 is turned off.

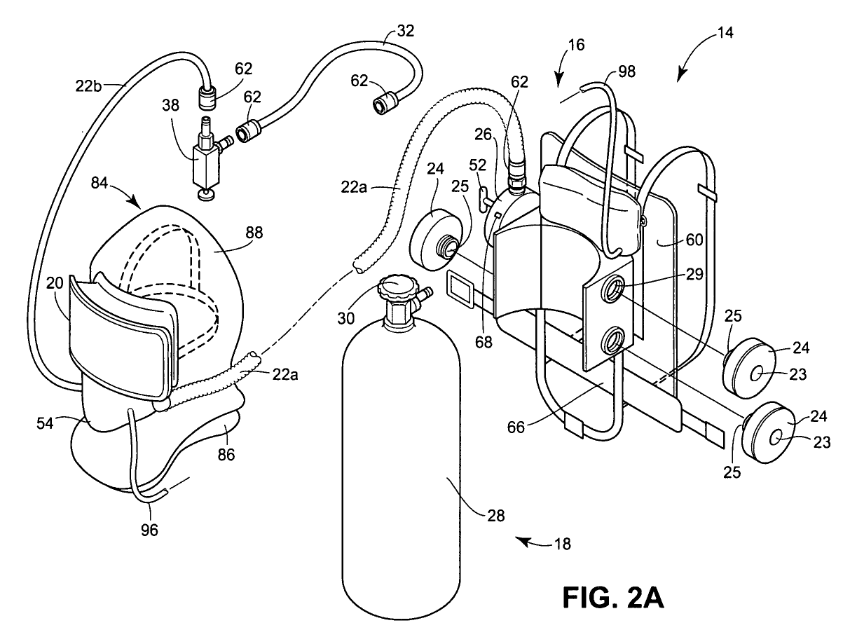

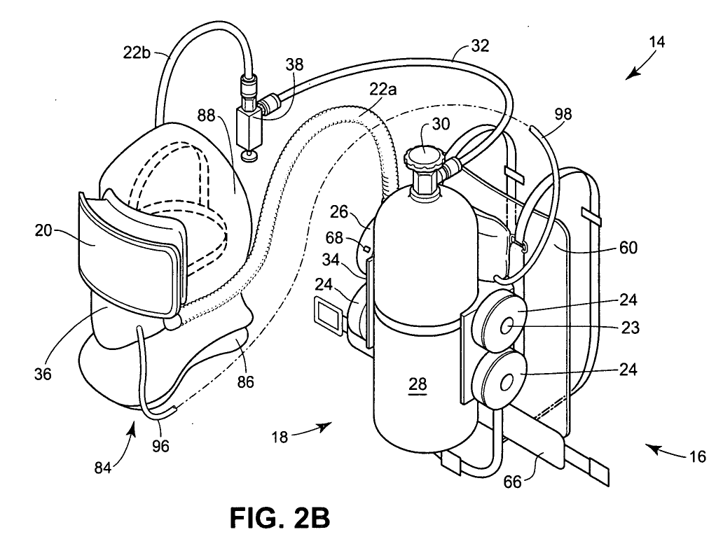

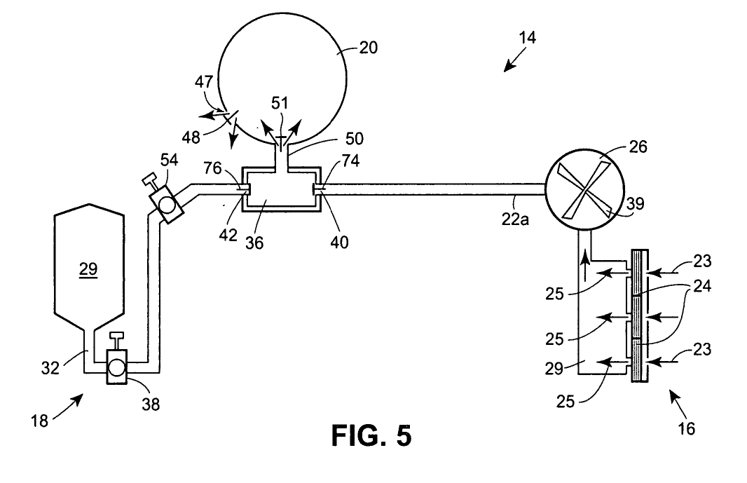

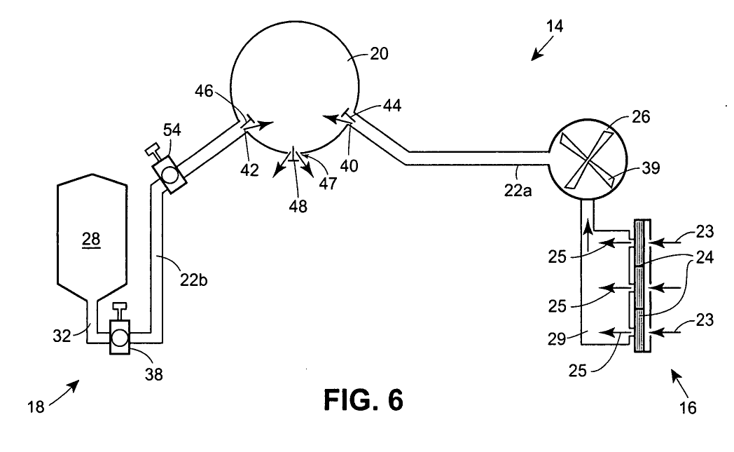

Referring now to FIGS. 2A and 2B, an alternate embodiment of the breathing apparatus 10 is depicted. This embodiment is essentially the same as the embodiment illustrated in FIGS. 1A and 1B except that the face mask 20 does not have a separate manifold 36. Instead, the air supply conduits 22a and 22b connect directly to the face mask 20 without connecting to an intermediate manifold 36; This configuration can be implemented in the same manner as the embodiments shown in FIGS. 3-5. In particular, the valve system in the face mask 20 can be operated in an automatic, semi-automatic, or manual mode. The embodiment of FIG. 2 is depicted schematically in FIG. 6. It should be noted that FIG. 6 is illustrated without a sensor 56, an alarm 69, or an electronically controlled blower switch 68 for simplicity only, but that the only difference relative to FIGS. 3-5 is a lack of a manifold positioned between the face mask 20 and the air supply sources, i.e., the PAPR 16 and the SCBA 18.

As illustrated in FIG. 6, separate ports 41, 43 are formed in the face mask 20 to allow the filtered air from the PAPR 16 and air from the SCBA 18, respectively, to enter the face mask 20. The entry ports 41, 43 are suitably adapted to be closed by one-way valves 44, 46 respectively. The inlet valves 44, 46 permit breathable air to flow into the face mask 20, but do not permit the air to flow out of the face mask 20 and back into either air supply system. As noted above, the inlet valves 44, 46 to the face mask 20 can be electro-mechanically actuated and can be operated automatically, semi-automatically, or manually. An outlet valve 48 located in the face mask 20 permits exhaled air to vent from the face mask 20 to the atmosphere. The outlet valve 48 is also a one-way valve that is designed to open only when the pressure in the face mask 20 is greater than the surrounding atmosphere.

Referring again to FIGS. 8A, 8B, and to FIG. 9, the harness 66 is adapted to attach the SCBA 18 and the PAPR 16 to the protective suit 12 of the user 58. The protective suit 12 can be used in unbreathable atmospheric environments caused by any number of contaminants such as fire, chemical agents, biological agents, and radiation. The protective suit 12 is made from a fluid-impervious material such that the suit 12 provides a complete physical barrier from the ambient contaminants. The suit 12 can be made from a laminated material structure having at least three layers (best seen in FIG. 9). The laminated materials can include an inner layer of fabric 78, an outer protective layer 80, and an intermediate layer 82 made from an impermeable fluoro-polymer barrier. The intermediate layer 82 is positioned between the inner and outer layers 78, 80. The suit 12 further includes the dual layer hood 84 discussed above in reference to FIGS. 1A and 1B.

The protective suit 12 can be ventilated to flush relatively warm humid air caused by the user's perspiration and heat output. The ventilation exchanges the warm humid air from the interior of the suit 12 with relatively cool filtered ambient air. Ventilated air can be forced through the suit 12, with the PAPR blower 26 or with a separate blower (not shown). In either case, a ventilation hose 90 can be connected directly to the blower 26 or can be teed into the conduit 22a such that a portion of the airflow is diverted to ventilate the suit 12. An exhaust port 92 is provided on the suit 12 with a one-way valve 94 to exhaust the warm humid air out of the suit 12 and to prevent contaminated ambient air from entering the exhaust port 92. Preferably, the blower 26 provides filtered air for suit ventilation at the rate of at least 6 cubic feet per minute.

The protective suit 12 can also include a camelback member 96 having a supply line 97 connected to the facemask 20. The camelback member 96 is operable for providing contaminant free liquid hydration to the user 58. The camelback member 96 includes a port 98 for receiving liquid, such as water, through a one-way valve (not shown). The port 98 may be configured to ensure that the camelback member 96 can be filled with liquid only when attached to a sealed container (not shown) for dispensing the liquid. The port 98 is adapted to open only when in sealed communication with the container so that hazardous environmental atmosphere is prevented from entering the protective suit 10 through the camelback member 96. In this manner, contaminate free liquid is stored in the camelback member 96 and can be supplied to the user through the supply line 97.

The face mask 20 provides clear vision at all times because exhaled warm humid air may be prevented from contacting the viewing lens. In particular, the filtered and relatively cool intake air may be blown across the face of the face mask 20 to keep the viewing lens clear, while the exhaled air egresses away from the viewing lens.

In operation, the protective suit 12 protects the user 58 from an environmentally hazardous atmosphere by keeping the contamination separated from the skin of the user 58 and by providing non-contaminated air for breathing. The operational characteristics of the protective suit 12 provides for a method of swapping air tanks 28 while the protective suit 12 is being worn without contaminating the air supply with unbreathable ambient air. Swapping air tanks 28 without contaminating the air supply can be implemented by using a quick connect coupling 62 that includes a pop off valve (not shown) configured to seal off the conduit 32 when the conduit 32 is removed from the air tank 28.

The foregoing detailed description has been given for clearness of understanding only, and no unnecessary limitations should be understood therefrom, as modifications will be obvious to those skilled in the art.

What is claimed is:

1. A breathing apparatus, comprising:
a face mask;
a self contained breathing apparatus including a tank and a first conduit adapted to carry air from the tank to a face mask;
a powered air purifying respirator having at least one filter, a blower, and a second conduit adapted to carry filtered ambient air to the face mask; and
a valve system operably coupled to the powered air purifying respirator and to the self contained breathing apparatus, the valve system adapted to permit selective control of the source of breathable air supplied to the face mask.

2. The breathing apparatus of claim 1, wherein the tank holds compressed air.

3. The breathing apparatus of claim 2, wherein the air is compressed to approximately 4,500 pounds per square inch (psi).

4. The breathing apparatus of claim 1, further comprising:
a first pressure regulator fluidly coupled between the tank and the face mask, the first pressure regulator adapted to reduce air pressure from the tank to a first reduced pressure.

5. The breathing apparatus of claim 4, wherein the first reduced pressure is approximately 100 psi.

6. The breathing apparatus of claim 4, further comprising:
a second pressure regulator fluidly coupled between the first pressure regulator and the face mask, the second pressure regulator adapted to reduce air pressure from the first reduced pressure to a pressure of approximately 14.69 psia.

7. The breathing apparatus of claim 1, further comprising:
a ballistic protective barrier positioned adjacent the tank and adapted to at least partially contain a tank rupture.

8. The breathing apparatus of claim 1, wherein the face mask is sealingly engageable with a face of a user to prevent ambient contaminants from entering the face mask.

9. The breathing apparatus of claim 1, wherein the first and second conduits each includes an expandable hose portion.

10. The breathing apparatus of claim 1, further comprising:
a quick coupling connector attached to opposing ends of at least one of the first and second conduits.

11. The breathing apparatus of claim 10, wherein each connector includes a pop off valve adapted to prevent airflow through the at least one of the conduits when the connector is disengaged from a mating receptacle.

12. The breathing apparatus of claim 1, wherein the valve system includes at least one control valve adapted to control the source of breathable air supplied to the face mask.

13. The breathing apparatus of claim 12, wherein the at least one valve is manually operated.

14. The breathing apparatus of claim 12, wherein the at least one valve is automatically operated by an electronic control.

15. The breathing apparatus of claim 1, further comprising a switch to control power to the blower.

16. The breathing apparatus of claim 15, wherein the switch is automatically controlled.

17. The breathing apparatus of claim 1, wherein the face mask further comprises:
a first inlet port in fluid communication with the powered air purifying respirator adapted to permit filtered breathable air to enter the face mask;
a second inlet port in fluid communication with the self contained breathing apparatus adapted to permit air from the tank to enter the face mask; and
an outlet port in fluid communication with a face mask adapted to exhaust exhaled air out of the face mask.

18. The breathing apparatus of claim 17, wherein each of the first and second inlet ports and the outlet port includes a one-way valve.

19. The breathing apparatus of claim 18, wherein the one-way valve associated with at least one of the first and second inlet ports is automatically controlled by electromechanical operation.

20. The breathing apparatus of claim 1, further comprising a harness adapted to hold the self contained breathing apparatus and powered air purifying respirator.

21. The breathing apparatus of claim 1, further comprising an air quality sensor adapted to sense contaminants in the filtered air.

22. The breathing apparatus of claim 21, wherein the sensor is operable for signaling an alarm when the filtered air reaches a predetermined contamination threshold.

23. The breathing apparatus of claim 22, wherein the alarm is at least one of an audio signal and a visual signal.

24. The breathing apparatus of claim 21, wherein the sensor is electronically coupled to the valve system and is adapted to automatically prevent airflow from the powered air purifying respirator from entering the face mask and is adapted to cause bottled airflow from the self contained breathing apparatus to flow into the face mask when a predetermined minimum air quality threshold is sensed.

25. The breathing apparatus of claim 1, further comprising a protective body suit adapted to prevent atmospheric contamination from penetrating the suit.

26. The breathing apparatus of claim 25, wherein the protective body suit is made from fluid impervious material.

27. The breathing apparatus of claim 25, wherein the protective body suit is made from laminated layers of material.

28. The breathing apparatus of claim 27, wherein the laminated layers of material include an impermeable fluoro-polymer barrier layer positioned between an inner and an outer layer of fabric.

29. The breathing apparatus of claim 25, wherein the protective suit includes a dual layer hood having an inner face skirt sealingly engaged with the face mask.

30. The breathing apparatus of claim 29, wherein the face mask includes a lens and wherein the dual layer hood includes an outer member tightly fitted around the lens of the face mask.

31. The breathing apparatus of claim 29, wherein the dual layer hood prevents liquid and vapor phase agents from penetrating an interface between the face mask and the dual layer hood.

32. The breathing apparatus of claim 25, further comprising a ventilation system operable for ventilating the protective body suit by flushing relatively warm humid air from the interior of the suit with filtered ambient air.

33. The breathing apparatus of claim 32, wherein the ventilation system includes a powered ventilation blower fluidly coupled to the protective body suit.

34. The breathing apparatus of claim 33, wherein the powered ventilation blower provides filtered air at a rate of approximately six cubic feet per minute.

35. The breathing apparatus of claim 1, further comprising a camelback member adapted to provide contaminate free liquid hydration to a user.

36. A breathing apparatus comprising:
a face mask;
a self contained breathing apparatus adapted to provide tank stored air to the face mask;
a powered air purifying respirator adapted to provide filtered ambient air to the face mask; and
a fluid impervious body suit coupled to the face mask.

37. The breathing apparatus of claim 36, wherein the body suit includes a plurality of layers of material.

38. The breathing apparatus of claim 37, wherein the layers of material include an impermeable fluoro-polymer barrier positioned between an inner layer and an outer layer of fabric.

39. The breathing apparatus of claim 36, wherein the face mask is sealingly engageable with a face of a user to prevent ambient contaminants from entering therein.

40. The breathing apparatus of claim 36, wherein the powered air purifying respirator is operably coupled with the self contained breathing apparatus to provide alternative sources of breathable air to the face mask.

41. The breathing apparatus of claim 40, further comprising at least one control valve to control the source of breathable air.

42. The breathing apparatus of claim 41, wherein the at least one control valve is manually operated.

43. The breathing apparatus of claim 41, wherein the at least one control valve is electrically actuated.

44. The breathing apparatus of claim 36, further comprising at least one conduit adapted to transport breathable air from the self contained breathing apparatus and the powered air purifying respirator to the face mask.

45. The breathing apparatus of claim 44, wherein the at least one conduit includes an expandable hose.

46. The breathing apparatus of claim 36, wherein the body suit further comprises a dual layer hood having an inner face skirt sealingly engaged with the face mask.

47. The breathing apparatus of claim 46, wherein the dual layer hood includes an outer member tightly fitted around a lens on the face mask.

48. The breathing apparatus of claim 46, wherein the dual layer hood prevents liquid and vapor phase agents from penetrating an interface between the face mask and the hood.

49. The breathing apparatus of claim 36, further comprising a ventilation system operable for ventilating the protective suit by flushing relatively warm humid air from the interior of the suit with filtered ambient air.

50. The breathing apparatus of claim 49, wherein the ventilation system includes a powered ventilation blower fluidly coupled to the body suit.

51. The breathing apparatus of claim 50, wherein the ventilation blower provides filtered air at a rate of approximately six cubic feet per minute.

52. The breathing apparatus of claim 36, further comprising a camelback member for providing contaminate free liquid hydration to a user.

53. The breathing apparatus of claim 36, further comprising an air quality sensor adapted to sense contaminants in the filtered ambient air.

54. The breathing apparatus of claim 53, wherein the sensor is operable for signaling an alarm if the filtered ambient air reaches a predetermined contamination threshold.

55. The breathing apparatus of claim 54, wherein the alarm is at least one of an audio signal and a visual signal.

56. The breathing apparatus of claim 53, wherein the sensor is electronically coupled to a valve system and is adapted to automatically prevent airflow from the powered air purifying respirator from entering the face mask and is adapted to cause air to flow from the self contained breathing apparatus into the face mask when a predetermined minimum air quality threshold is sensed.

57. A method of providing airflow to a face mask comprising:
operating a powered blower to provide forced filtered air from a powered air purifying respirator to the face mask;
opening a valve connecting the face mask to a self contained breathing apparatus compressed air tank;
closing a valve connecting the powered air purifying respirator and the facemask to prevent filtered air from entering the face mask when air is flowing from the compressed air tank; and
opening the valve to the powered air purifying respirator when the bottled air pressure from the tank falls below a threshold pressure.

58. The method of claim 57 further comprising flowing filtered air to the face mask by resistance breathing if the powered blower shut off.

59. The method of claim 57 further comprising swapping air tanks without contaminating the air supply with unbreathable ambient air.

60. A method of providing clear vision through a face mask breathing apparatus having a self contained breathing apparatus adapted to provide tank stored air to the face mask and a powered air purifying respirator adapted to provide filtered ambient air to the face mask, comprising:
blowing filtered inlet air across a lens of the face mask; and
flowing exhaled air out of the face mask away from an interior of the lens of the face mask.

61. A method of operating a breathing apparatus comprising:
at a first time operating a powered air purifying respirator to provide breathable filtered airflow to a face mask;
at a second time operating a self contained breathing apparatus to provide breathable bottled airflow to a face mask; and
operating a valve system to selectively control the source of breathable airflow.

62. The method claim 61, further comprising automatically controlling the valve system in response to an air quality sensor.

63. The method claim 61, further comprising manually controlling the valve system.
